(19) United States
(12) Patent Application Publication
(10) Pub. No.: US 2011/0201731 A1
(43) Pub. Date: Aug. 18, 2011

(54) METHOD FOR PREPARING A THERMOPLASTIC COMPOSITE MATERIAL CONTAINING NANOTUBES PARTICULARLY CARBON NANOTUBES

(75) Inventors: Alexander Korzhenko, Pau (FR); Benoit Brule, Beaumint-Le-Roger (FR); Aude Chiquot, Bernay (FR); Patrick M. Piccione, Bekshire (GB); Pierre Miaudet, Jurancon (FR); Amelie Merceron, Aussevielle (FR)

(73) Assignee: Arkema France, Colombes (FR)

(21) Appl. No.: 13/125,629

(22) PCT Filed: Oct. 22, 2009
(86) PCT No.: PCT/FR2009/052034

§ 371 Date: Apr. 22, 2011

Related U.S. Application Data
(60) Provisional application No. 61/235,471, filed on Aug. 20, 2009.

(30) Foreign Application Priority Data
Oct. 22, 2008 (FR) 0857173
Mar. 23, 2009 (FR) 0951843

(51) Int. Cl. C08K 13/04; C08L 9/06; C08L 77/06; C08L 69/00; C08L 71/08; C08K 5/12; C08K 5/435; C08K 5/523; C08K 5/053; C08K 5/315; B82B 3/00

(52) U.S. Cl. 524/127; 524/562; 524/606; 524/611; 524/612; 524/297; 524/169; 524/386; 524/209; 977/742

(57) ABSTRACT

One subject of the present invention is a method for preparing a composite preferably containing 10 to 50% by weight of nanotubes, comprising:
(a) the introduction, into a mixer, of nanotubes and at least one thermoplastic polymer, such as a homopolyamide or copolyamide, a polycarbonate, SBM or a PEG;
(b) the melting of the thermoplastic polymer; and
(c) the mixing of the molten thermoplastic polymer and the nanotubes,
provided that aplasticizer is introduced upstream of, or in, the melting zone of the polymer.

The invention also relates to the composite thus obtained and to its use in the manufacture of a composite product.

The present invention relates to a method for preparing composites based on nanotubes, especially carbon nanotubes, to the composites thus obtained and to their use for the manufacture of composite products.

Carbon nanotubes (or CNTs) possess particular crystalline structures, of tubular shape, which are hollow and closed, made up of atoms arranged regularly in the form of pentagons, hexagons and/or heptagons, obtained from carbon. CNTs generally consist of one or more rolled-up graphite sheets. A distinction must thus be made between single-walled nanotubes or SWNTs and multi-walled nanotubes or MWNTs.

CNTs are commercially available or can be prepared by known methods. There are several methods for synthesizing CNTs, especially by electrical discharge, by laser ablation and by CVD (chemical vapour deposition) enabling large quantities of carbon nanotubes to be manufactured, and therefore obtained for a manufacturing cost compatible with their bulk use. This method specifically consists in injecting a carbon source at relatively high temperature onto a catalyst, which may itself consist of a metal such as iron, cobalt, nickel or molybdenum, which is supported on an inorganic solid such as alumina, silica or magnesia. The carbon sources may be methane, ethane, ethylene, acetylene, ethanol, methanol or even a mixture of carbon monoxide and hydrogen (the HIPCO process).

From a mechanical standpoint, the CNTs exhibit excellent stiffness (measured by Young's modulus), comparable to that of steel, while at the same time being extremely light. Furthermore, they exhibit excellent electrical and thermal conductivity properties making it possible to envisage using them as additives in order to confer these properties on various materials, specially macromolecular materials.

At the same time, it has been suggested to use CNT-based composites for stiffening and/or thickening liquid formulations, especially aqueous formulations such as paints (WO 2007/135323).

Various approaches have been envisaged up till now for dispersing moderate amounts of CNTs in polymer matrices, for the purpose in particular of improving their electrostatic dissipation capability without affecting their mechanical properties, and thus to allow the manufacture, from said matrices, of electronic components or coating panels, for example for the motor vehicle industry.

From the industrial standpoint, it would however be desirable to provide composites highly filled with CNTs and capable of being diluted to the desired concentration in various polymer matrices.

However, CNTs prove to be difficult to handle and disperse, because of their small size, their pulverulence and possibly, when they are obtained by the CVD technique, their entangled structure which moreover generates strong Van der Waals interactions between their molecules.

Certain solutions have been proposed to make it easier to disperse CNTs in a polymer matrix. Among these, mention may be made of sonication which has however only a temporary effect, or ultrasonication, which has the effect of partly cutting the nanotubes and of creating oxygen-containing functional groups that may affect some of their properties. Another solution consists in producing a CNT dispersion in a solvent and a monomer and in carrying out an in situ polymerization resulting in the formation of functionalized CNTs. This solution is however complex and may prove to be expensive depending on the products used. Moreover, the grafting operations run the risk of damaging the structure of the nanotubes and, as a consequence, their electrical and/or mechanical properties.

Furthermore, attempts have been made to mix CNTs with a thermoplastic polymer matrix in a compounding tool conventionally used for obtaining composites based on thermoplastic polymers. However, it has been observed that, in this case, introducing a large amount (greater than 10% by weight) of CNTs into the polymer matrix generally has the effect of increasing the viscosity of the compound in the mixing tool, resulting in the screw of the mixer being stopped, requiring the line speed to be reduced and consequently having a negative impact on productivity. Furthermore, stiffening the composite may result in self-heating which may lead to degradation of the polymer and consequently, in the presence of the CNTs, the formation of a contaminating coating on the walls of the barrel and the screws of the mixer. This results not only in unacceptable contamination of the composite but also in an increase in the power drawn by the mixer (about 10% over 10 hours of mixing), which then exceeds the power limit of the machine and causes an inadvertent stoppage of said machine. The mixer must then be unblocked and cleaned, thus resulting in a production stoppage.

There is therefore still a need to provide a simple and inexpensive industrial method for continuously preparing composites containing at least 10% by weight of nanotubes, especially carbon nanotubes, in polymer matrices, without appreciably degrading either the nanotubes or the matrix, and without contaminating the equipment.

The Applicant has discovered that this need can be satisfied by implementing a method comprising the contacting of the nanotubes with a plasticizing agent introduced into the mixer upstream of the melting zone of the polymer.

Admittedly, it has already been suggested, in US 2004/0262581, to introduce a plasticizer into a mixer of a polymer and CNTs in order to reduce the viscosity of the mixture. The objective pursued in that document is to reduce the shear forces and thus maintain a satisfactory appearance and a homogeneous distribution of the CNTs, to improve the effectiveness of the CNTs and consequently to give the polymer a given electrical resistivity at a lower CNT content (around 5%). This document therefore does not relate to the manufacture of composites containing more than 10% CNT by weight, so that the problems of stiffening mixtures having high CNT contents do not arise. Furthermore, the way in which the plasticizer is introduced is not critical since it is possible for the CNTs and the polymer to be introduced simultaneously, in a blender placed upstream of the mixer, or separately, downstream of the melting zone of the polymer.

Now, the Applicant has demonstrated that introducing the plasticizer downstream of the melting zone of the polymer results in unacceptable overheating of compounds having a high CNT content.

Furthermore, it has been suggested, in US 2007/202287, to introduce CNTs dispersed in a plasticizer and a polyamide matrix into a two-screw extruder, in order to prepare a composite suitable for manufacturing fuel hoses. According to this document, the obtained composite contains 7% to 15% of CNTs and is intended to be implemented as it is in a tube shape, or to be formed into pellets. It would be then desirable to provide a mean for dispersing larger amounts of CNTs into any polymer matrix, and not only polyamide matrix, so as to prepare master batches with large amounts of CNTs and suitable for being used for manufacturing various mechanical or electronical pieces of different polymers.

The inventors have found out that this goal could be achieved, and that a more flexible method than the one described in the above-cited document could be implemented when the polymer matrix is at least partially in the form of a powder. Indeed, it has been demonstrated that the use of a polymer at least partially in the form of a powder, and not exclusively in the form of pellets, leads to a better dispersion of a large amount of CNTs in the matrix, and consequently to better mechanical and electrical properties of the obtained composite.

Once subject of the present invention is thus a method for preparing a composite containing 10 to 50% by weight of nanotubes, comprising:

(a) the introduction, into a mixer, of a polymeric composition containing at least one thermoplastic polymer and nanotubes;

(b) the melting of the thermoplastic polymer; and

(c) the mixing of the molten thermoplastic polymer and the nanotubes,

the method further including the addition of at least one plasticizer into the mixer, in a weight ratio of 10 to 400% by weight, relative to the weight of nanotubes employed, at least 50% of the weight of plasticizer being introduced upstream of, or in, the melting zone of the polymer,

provided that, if the plasticizer, the thermoplastic polymer and the nanotubes are introduced simultaneously or in succession into the same feed hopper of the mixer, the polymer is in the form of a powder/granule mixture ranging from 10:90 to 100:0, preferably predominantly in powder form.

The method according to the invention is carried out in a mixer, which is advantageously a compounding device.

The term “compounding device” is understood, according to the invention, to mean an apparatus conventionally used in the plastics industry for the melt compounding of thermoplastic polymers and additives for the purpose of producing composites. In this apparatus, the polymeric composition and the additives are mixed using a high-shear device, for example a corotating twin-screw extruder or a co-kneader. The molten material generally exits the apparatus in agglomerated solid physical form, for example in the form of granules, or in the form of rods which, after cooling, are chopped into granules.

Examples of co-kneaders that can be used according to the invention are BUSS® MDK 46 co-kneaders and those of the BUSS® MKS or MX series, sold by Buss AG, which all consist of a screw shaft provided with flights, which is placed in a heated barrel possibly consisting of several sections, and the internal wall of said barrel being provided with kneading teeth designed to cooperate with the flights so as to shear the kneaded material. The shaft is rotated and provided with an oscillatory movement in the axial direction by a motor. These co-kneaders may be equipped with a granulating system fitted for example at their exit orifice, which may consist of an extrusion screw or a pump.

The co-kneaders that can be used according to the invention preferably have a screw L/D ratio ranging from 7 to 22, for example from 10 to 20, whereas the corotating extruders advantageously have an L/D ratio ranging from 15 to 56, for example from 20 to 50.

Furthermore, the compounding step is generally carried out at a temperature ranging from 30 to 320° C., for example from 70 to 300° C. This temperature, which is above the glass transition temperature (T_{g}) in the case of amorphous thermoplastic elastomers and above the melting point in the case of semicrystalline thermoplastic polymers, depends on the polymer specifically used and is generally mentioned by the polymer supplier.

The Applicant has demonstrated that this method allows better control of the polymer matrix temperature and thus ensures stability of the method (by maintaining a steady power consumption at an acceptable level), but also ensures that novel composites that are less contaminated and easier to granulate, which contain high amounts of well-dispersed CNTs, can be obtained without the rod obtained breaking.

The Applicant has also observed that this composite is easier to dilute in a polymer matrix (without having in particular to use ultrasound) than composites not containing a plasticizer and that this dilution can be carried out at lower temperature in order to give the composite product obtained the desired conductivity. This thus results in more economic processing of the composite obtained according to the invention.

The nanotubes that can be used according to the invention may be carbon nanotubes (hereafter called CNTs) or nanotubes based on boron, phosphorus or nitrogen, or else nanotubes containing several of these elements, or at least one of these elements in combination with carbon. Advantageously, they are carbon nanotubes. They may be of the single-walled, double-walled or multi-walled type. Double-walled nanotubes may in particular be prepared as described by Flahaut et al. in Chem. Com. (2003), 1442. As regards multi-walled nanotubes, these may be prepared as described in document WO 03/02456.

The nanotubes used according to the invention usually have an average diameter ranging from 0.1 to 200 nm, preferably from 0.1 to 100 nm, more preferably from 0.1 to 50 nm and better still from 1 to 30 nm, for instance from 3 to 30 nm, and advantageously have a length of more than 0.1 μm and advantageously from 0.1 to 20 μm, for example about 6 μm. Advantageously, their length/diameter ratio is greater than 10 and usually greater than 100. These nanotubes therefore comprise particularly what are called VGCF (vapour-grown carbon-fibre) nanotubes. Their specific surface area is for example between 100 and 300 m²/g and their bulk density may in particular be between 0.01 and 0.5 g/cm³ and more preferably between 0.07 and 0.2 g/cm³. The carbon nanotubes according to the invention are preferably multi-walled carbon nanotubes and may for example comprise 5 to 15 sheets and more preferably 7 to 10 sheets.

An example of raw carbon nanotubes is in particular commercially available from the company Arkema under the brand name Graphistrength® C100.

The nanotubes may be purified and/or treated (in particular oxidized) and/or milled before they are used in the method according to the invention. They may also be functionalized by chemical methods in solution, such as animation or reaction with coupling agents.

According to the invention, the CNTs are advantageously in powder form.

The milling of the nanotubes may in particular be carried out cold or hot using known processing techniques in equipment such as ball mills, hammer mills, grinding mills, knife or blade mills, gas jets or any other milling system that can reduce the size of the entangled network of nanotubes. It is preferable for this milling step to be carried out using a gas jet milling technique, in particular in an air jet mill.

The nanotubes may be purified by washing with a solution of sulphuric acid or another acid, so as to strip them of any residual metallic or mineral impurities resulting from their method of preparation. The weight ratio of nanotubes to sulphuric acid may especially be between 1/2 and 1/3. The purifying operation may also be carried out at a temperature ranging from 90 to 120° C., for example for a time of 5 to 10 hours. This operation may advantageously be followed by steps in which the purified nanotubes are rinsed with water and dried. Another way of purifying the nanotubes, intended in particular for removing iron and/or magnesium that they contain consists in subjecting them to a heat treatment above 1000° C.

Advantageously, the oxidation of the nanotubes is carried out by bringing them into contact with a sodium hypochlorite solution containing 0.5 to 15% NaOCl by weight and preferably 1 to 10% NaOCl by weight, for example in a nanotube/sodium hypochlorite weight ratio ranging from 1/0.1 to 1/1. Advantageously, the oxidation is carried out at a temperature below 60° C. and preferably at room temperature, for a time ranging from a few minutes to 24 hours. This oxidation operation may advantageously be followed by steps in which the oxidized nanotubes are filtered and/or centrifuged, washed and dried.

However, it is preferable for the nanotubes to be used in the method according to the invention in the raw state. It has in fact been demonstrated that a preliminary surface treatment of the nanotubes is unnecessary. The Applicant believes that the plasticizer, which is introduced in the method according to the invention before the nanotubes are brought into contact with the molten polymer, is absorbed on the surface of the nanotubes, although not being tied to this theory, the effect of the absorption being:
to improve the wettability of the nanotubes by the molten polymer; and
to reduce the interactions between the nanotubes and thus make it easier to disperse them in the polymer during the compounding (or mixing) phase.

Moreover, it is preferable according to the invention to use nanotubes obtained from raw materials derived from renewable sources, particularly plant sources, as described in document FR 2 914 634.

The amount of nanotubes used according to the invention represents from 10 to 50% by weight, preferably from 15 to 50% by weight, for instance from 15 to 40% by weight and more preferably from 20 to 50% by weight, for instance from 20 to 35% by weight relative to the total weight of the composite.

In the method according to the invention, the nanotubes (whether raw or milled and/or purified and/or oxidized and/or functionalized by a non-plasticizing molecule) are brought into contact with at least one thermoplastic polymer.

The term “thermoplastic polymer” is understood, in the context of the present invention, to mean a polymer that melts when it is heated and which can be formed and reformed in the melt state.

This thermoplastic polymer may in particular be selected from: olefin homopolymers and copolymers, such as acrylonitrile-butadiene-styrene copolymers, styrene-butadiene-alkyl methacrylate copolymers (SBM), polyethylene, polypropylene, polybutadiene and polybutylene; acrylic homopolymers and copolymers and polyalkyl (meth)acrylates, such as polymethyl methacrylate; homopolyamides and copolyamides; polycarbonates; polyesters, including polyethylene terephthalate and polybutylene terephthalate; polyethers, such as polyphenylene ether, polyoxymethylene, polyoxyethylene or polyethylene glycol and polyoxypropylene; polystyrene; styrene/maleic anhydride copolymers; polyvinyl chloride; fluoropolymers, such as polyvinylidene fluoride, polytetrafluoroethylene and polychlorotrifluoroethylene; natural or synthetic rubbers; thermoplastic polyurethanes; polyaryletherketones (PAEK), such as polyetheretherketone (PEEK) and polyetherketoneketone (PEKK); polyetherimide; polysulphone; polyphenylenesulphide; cellulose acetate; polyvinyl acetate; and blends thereof.

According to one particularly preferred embodiment of the invention, the polymer is selected from homopolyamides and copolyamides.

Among homopolyamides (PA), mention may in particular be made of: PA-6, PA-11 and PA-12, these being obtained by the polymerization of an amino acid or of a lactam; PA-6,6, PA-4,6, PA-6,10, PA-6,12, PA-6,14, PA-6,18 and PA-10,10, these being obtained by the polycondensation of a diacid and a diamine; and aromatic polyamides, such as polyarylamides and polyphthalamides. Among the aforementioned polymers, PA-11, PA-12, and aromatic PAs are in particular available from the company Arkema under the brand name Rilsan®.

The copolyamides, or polyamide copolymers, may be obtained from various starting materials: (i) lactams; (ii) aminocarboxylic acids; or (iii) equimolar quantities of diamines and dicarboxylic acids. The formation of a copolyamide requires at least two different starting products to be selected from those mentioned above. The copolyamide then comprises at least these two units. It may thus involve a lactam and an aminocarboxylic acid having a different number of carbon atoms, or two lactams having different molecular weights, or else a lactam combined with an equimolar amount of a diamine and of a dicarboxylic acid. The lactams (i) may in particular be selected from lauryllactam and/or caprolactam. The aminocarboxylic acid (ii) is advantageously selected from α,ω-aminocarboxylic acids, such as 11-aminoundecanoic acid or 12-aminododecanoic acid. As regards the precursor (iii), this may in particular be a combination of at least one C₆-C₃₆, aliphatic, cycloaliphatic or aromatic, dicarboxylic acid, such as adipic acid, azelaic acid, sebacic acid, brassylic acid, n-dodecanedioic acid, terephthalic acid, isophthalic acid or 2,6-naphthalene dicarboxylic acid with at least one C₄-C₂₂, aliphatic, cycloaliphatic, arylaliphatic or aromatic, diamine such as hexamethylenediamine, piperazine, 2-methyl-1,5-diaminopentane, m-xylylenediamine or p-xylylenediamine, it being understood that said dicarboxylic acid(s) and diamine(s) are used, when they are present, in equimolar amounts. Such copolyamides are in particular sold under the brand name Platamid® by the company Arkema.

In another embodiment, the polymer may be selected from the styrene-butadiene-alkyl methacrylate copolymers, especially in C₁ to C₈ (or SEM), in particular:

1) triblock copolymers based on polystyrene, 1,4-polybutadiene and polymethyl-methacrylate (PMMA), that may be obtained by anionic polymerization as described in EP 0 524 054 and EP 0 749 987. An example of such copolymer contains 10 to 25% by weight of polystyrene (Mn=10,000 to 30,000 g/mol for example), 5 to 30% by weight of polybutadiene (Mn=10,000 to 25,000 g/mol for example) and 50 to 70% by weight of PMMA (Mn=40,000 to 90,000 g/mol for example). Such copolymers are in particular available in powder form from the company ARKEMA under the trade name Nanostrength® E41;

2) core/shell type copolymers composed of a core coated with one or more shells, in which the core contains a homopolymer or a copolymer of butadiene, styrene and/or alkylmethacrylate, in particular in C₁ to C₈, especially a styrene-butadiene copolymer, and in which at least one shell, and preferably each shell, contains a styrene and/or alkylmethacrylate homopolymer or copolymer, especially in C₁ to C₈. The core may thus be coated with a polystyrene internal shell and a PMMA external shell. Such core/shell copolymers are in particular described in WO 2006/106214. A SBM core/shell copolymer suitable for the present invention is especially marketed by the company ARKEMA under the trade name Durastrength® E920.

The polymeric composition used according to the invention may contain, apart from the thermoplastic polymer, various additives intended in particular to promote the subsequent dispersion of the composite in a liquid formulation, such as polymeric dispersants, in particular carboxymethyl cellulose, acrylic polymers, the polymer sold by the company Lubrizol under the brand name Solplus® DP310 and functionalized amphiphilic hydrocarbons such as those sold by the company Trillium Specialties under the brand name Trilsperse® 800, surfactants such as sodium dodecylbenzenesulphonate and mixtures thereof. The polymeric composition may also contain fillers, for example fillers based on graphene other than nanotubes (particularly fullerenes), silica or calcium carbonate. It may also contain UV filters, especially those based on titanium dioxide, and/or flame retarders. It may, as a variant or in addition, contain at least one solvent of the thermoplastic polymer.

In the method according to the invention, this polymeric composition is brought into contact with the aforementioned nanotubes and with at least one plasticizer.

The term “plasticizer” is understood to mean, in the context of the present invention, a compound which, introduced into a polymer, increases its flexibility, reduces its glass transition temperature (T_{g}) and increases its malleability and/or its extensibility.

Among the plasticizers that can be used according to the invention, mention may in particular be made of:
phosphate alkyl esters and alkyl esters of hydrobenzoic acid (the preferably linear alkyl group of which contains 1 to 20 carbon atoms), of lauric acid, of azelaic acid and of pelargonic acid;
arylphosphates;
phthalates, especially dialkyl or alkylaryl phthalates, in particular alkybenzyl phthalates, the alkyl groups, which are linear or branched, independently containing 1 to 12 carbon atoms;
nitrile resin;
cyclized polybutylene terephthalate and mixtures containing such, for example the resin CBT® 100 sold by Cyclics Corporation;
adipates, especially dialkyl adipates, for example di(2-ethylhexyl);
sebacates, especially dialkyl sebacates and in particular dioctyl sebacate;
glycol benzoates or glycerol benzoates;
dibenzyl ethers,
chloroparaffins;
functionalized amphiphilic hydrocarbons such as those sold by Trillium Specialties under the brand name Trilsperse® 800;
propylene carbonate;
sulphonamides, in particular alkylsulphonamides, arylsulphonamides and arylalkylsulphonamides, the aryl group of which is optionally substituted by at last one alkyl group containing 1 to 12 carbon atoms, such as benzenesulphonamides and toluenesulphonamides, said sulphonamides possibly being N-substituted or N,N-disubstituted by at least one preferably linear alkyl group containing 1 to 20 carbon atoms, said alkyl group optionally having an alkyl ester, an alkyl amide or an (alkyl ester) alkyl amide group;
salts of N-alkyl guanidine, the alkyl group of which is preferably linear and contains 6 to 16 carbon atoms;
glycols, such as propylene glycol; and
mixtures thereof.

Among the abovementioned plasticizers, those preferred for use in the present invention comprise sulphonamides, aryl phosphates, phthalates, nitrile resins and mixtures thereof. Examples of such plasticizers are in particular: N-butylbenzenesulphonamide (BBSA), N-ethylbenzenesulphonamide (EBSA), N-propylbenzenesulphonamide (PBSA), N-butyl-N-dodecylbenzenesulphonamide (BDBSA), N,N-dimethyl-benzenesulphonamide (DMBSA), para-methylbenzenesulphonamide, ortho-toluenesulphonamide, para-toluenesulphonamide, resorcinol bis(diphenyl phosphate), bisphenol A bis(diphenyl phosphate), neopentylglycol bis(diphenyl phosphate), dioctylphthalate, glycols, cyclized polybutylene terephthalate, functionalized amphiphilic hydrocarbons and mixtures thereof.

Mention may also be made of the plasticizers described in Patent Application EP 1 873 200

The plasticizer may be used in an amount of 10 to 400% by weight, preferably 50 to 200% by weight and more preferably 75 to 150% by weight relative to the weight of nanotubes employed. It may thus represent, for example, from 5 to 80% by weight and more generally from 10 to 30% by weight relative to the total weight of the composite.

Of course, the choice of plasticizer used according to the present invention will depend on the chemical nature of the matrix to be reinforced by the nanotubes. Table 1 below gives by way of indication a few examples of particularly appropriate plasticizer/polymer matrix combinations.

TABLE 1
Examples of polymer/plasticizer combinations

| Type of polymer to be | Examples of plasticizers that can |
|---|---|
| reinforced | be used |
| Acrylonitrile-butadiene- | Phosphate alkyl esters, aryl |
| styrene (ABS) copolymer | phosphates, aryl sulphonamides, |
| | resin CBT ® 100 |
| Styrene-butadiene-alkyl | Phthalates, especially dioctyl |
| methacrylate copolymer | phthalate, nitrile resin |
| Polymethyl methacrylate | Phthalates, especially di-(2- |
| (PMMA) | ethylhexyl) phthalate, resin CBT ® |
| | 100 |
| Styrene/ethylene/ | Phthalates, especially dioctyl |
| butadiene/styrene (SEBS) | phthalate |
| copolymer | |
| Ethylene-propylene-diene | Phthalates, especially dibutyl or |
| monomer (EPDM) copolymer | dioctyl phthalate |
| Natural rubber (SBR) | Sebacates, especially dioctyle |
| | sebacate; phthalates, especially |
| | dibutyl or dioctyl phthalate |
| Polybutylene | Adipates, phthalates, pelargonates |
| Polyamides | Sulphonamides, especially BBSA, |
| | EBSA, PBSA, BDBSA and DMBSA; |
| | hydroxybenzoates, such as 1-butyl- |
| | 4-hydroxybenzoate or hexadecyl- |
| | 4-hydroxybenzoate; phthalates, |
| | especially dioctyl or diisodecyl |
| | phthalate; adipates, especially di- |
| | (2-ethylhexyl) adipate; phosphates, |
| | especially tri-(2-éthylhexyle) |
| | phosphate |
| Polycarbonates | Phosphate alkyl esters, aryl |
| | phosphates, phthalates, resin CBT ® |
| | 100 |
| Polyesters (including | Glycols, phthalates |
| PET) | |
| Polyphenylene ether | Glycols, phthalates, resin CBT ® |
| | 100 |
| Polystyrene | Phthalates, aryl phosphates, |
| | sebacates, adipates, azelates |
| Polyethylene, PEG and | Phthalates, especially dioctyl |
| copolymers of low | phthalate; glycerol benzoates, |
| molecular weight | especially glyceryl tribenzoate; |
| | glycols |
| Polypropylene | Sebacates, especially dioctyl |
| | sebacate |
| Polyvinylchloride (PVC) | Dialkyl phthalates, dialkyl |
| | adipates, azelates, sebacates, |
| | resin CBT ® 100 |
| Fluoropolymers | Phthalates, adipates, azelates, |
| | sebacates |

The present invention relates to methods applied to given polymer/plasticizer pairings.

Thus, another subject of the invention is a method for preparing a composite, preferably containing 10 to 50% by weight of nanotubes, comprising:

(a) the introduction, into a mixer, of nanotubes and a polymeric composition containing at least one thermoplastic polymer comprising a homopolyamide or copolyamide;

(b) the melting of the thermoplastic polymer; and

(c) the mixing of the molten thermoplastic polymer and the nanotubes,

the method further including the addition of at least one plasticizer into the mixer, selected from sulphonamides, hydroxybenzoates, phthalates, adipates and phosphates,

in a weight ratio of 10 to 400% by weight relative to the weight of nanotubes employed, at least 50% of the weight of the plasticizer being introduced upstream of, or in, the melting zone of the polymer,

provided that, if the plasticizer, the thermoplastic polymer and the nanotubes are introduced simultaneously or in succession into the same feed hopper of the mixer, the polymer is in the form of a powder/granule mixture ranging from 10:90 to 100:0, preferably predominantly in powder form.

The subject of the invention is also a method for preparing a composite, preferably containing 10 to 50% by weight of nanotubes, comprising:

(a) the introduction, into a mixer, of nanotubes and a polymeric composition containing at least one thermoplastic polymer comprising a polycarbonate;

(b) the melting of the thermoplastic polymer; and

(c) the mixing of the molten thermoplastic polymer and the nanotubes,

the method further including the addition of at least one plasticizer into the mixer, selected from phosphate alkyl esters, aryl phosphates and phthalates,

in a weight ratio of 10 to 400% by weight relative to the weight of nanotubes employed, at least 50% of the weight of the plasticizer being introduced upstream of, or in, the melting zone of the polymer.

Another subject of the invention is a method for preparing a composite, preferably containing 10 to 50% by weight of nanotubes, comprising:

(a) the introduction, into a mixer, of nanotubes and a polymeric composition containing at least one thermoplastic polymer comprising a styrene-butadiene-methyl methacrylate copolymer;

(b) the melting of the thermoplastic polymer; and

(c) the mixing of the molten thermoplastic polymer and the nanotubes,

the method further including the addition of at least one plasticizer into the mixer, selected from phthalates and nitrile resins,

in a weight ratio of 10 to 400% by weight relative to the weight of nanotubes employed, at least 50% of the weight of the plasticizer being introduced upstream of, or in, the melting zone of the polymer.

Yet another subject of the invention is a method for preparing a composite, preferably containing 10 to 50% by weight of nanotubes, comprising:

(a) the introduction, into a mixer, of nanotubes and a polymeric composition containing at least one thermoplastic polymer comprising a polyethylene glycol;

(b) the melting of the thermoplastic polymer; and

(c) the mixing of the molten thermoplastic polymer and the nanotubes,

the method further including the addition of at least one plasticizer into the mixer, selected from glycols,

in a weight ratio of 10 to 400% by weight relative to the weight of nanotubes employed, at least 50% of the weight of the plasticizer being introduced upstream of, or in, the melting zone of the polymer.

As indicated above, at least 50% of the weight of the plasticizer employed is introduced into the mixer upstream of, or in, the melting zone of the polymer.

In a first embodiment of the invention, more particularly suitable for liquid plasticizers, the plasticizer is introduced completely or partly at the start of the melting zone of the polymer. In general, it is preferred to introduce from 50 to 100%, for example from 60 to 80%, by weight of the plasticizer in this zone and from 0 to 50% by weight, for example from 20 to 90% by weight, of the plasticizer downstream of the melting zone of the polymer.

In a second embodiment of the invention, the plasticizer, the thermoplastic polymer and the nanotubes may, as a variant, be introduced simultaneously or in succession into the same feed hopper of the mixer. In general, it is preferred to introduce all of the plasticizer in this hopper. The aforementioned materials may be introduced in succession, in any order, either directly into the hopper or into a suitable container where they are homogenized before being introduced into the hopper.

In this embodiment, the polymer is in the form of a powder/granule mixture ranging from 10:90 to 100:0, preferably the polymer is predominantly in powder form rather than in granule form. The Applicant has in fact demonstrated that this results in better dispersion of the nanotubes in the polymer matrix and better conductivity of the composite obtained. In practice, a blend of polymer in powder form and of polymer in granule form may be used in a polymer powder/polymer granule weight ratio ranging from 70/30 to 100/0, more preferably from 90/10 to 100/0.

This second embodiment of the invention is very suitable for solid plasticizers. These may possibly be introduced into the feed hopper of the mixer in the form of a precomposite with the nanotubes. Such a precomposite, containing 70% by weight of cyclized polybutylene terephthalate as plasticizer and 30% by weight of multi-walled nanotubes, is for example available commercially from the company Arkema under the brand name Graphistrength® C M12-30.

However, this embodiment of the invention may also be employed if the plasticizer is in the liquid state. In this case, the nanotubes and the plasticizer may be introduced into the hopper or the aforementioned container in precomposite form. Such a precomposite may for example be obtained using a process involving:

1—the contacting of a plasticizer in liquid form, possibly in the molten state or in solution in a solvent, with the powdered nanotubes, for example by direct introduction or dispersion by pouring the plasticizer into the nanotube powder or, on the contrary, by introducing the plasticizer drop by drop into the powder or by spraying the plasticizer using a sprayer onto the nanotube powder; and

2—the drying of the precomposite obtained, possibly after removal of the solvent (typically by evaporation).

The first step above may be carried out in the conventional synthesis reactors, blade mixers, fluidized-bed reactors or mixing equipment of the Brabender, Z-blade mixer or extruder type. It is generally preferable to use a cone mixer, for example of the Vrieco-Nauta type from Hosokawa, comprising a rotary screw rotating along the wall of a conical vessel.

As a variant, in the second embodiment of the invention, a precomposite may be formed from the liquid plasticizer and the thermoplastic polymer, before these are mixed with the nanotubes.

After the method according to the invention has been completed, a composite is obtained. The subject of the invention is also the composite that can be obtained according to the above method.

This composite may be used as such, or may be used as a masterbatch, and therefore diluted in a polymer matrix in order to form a composite polymer.

Another subject of the invention is the use of the composite described above for the manufacture of a composite product and/or for the purpose of conferring at least one electrical, mechanical and/or thermal property on a polymer matrix.

Yet another subject of the invention is a process for manufacturing a composite comprising:

the manufacture of a composite by the method according to the method described above; and

the introduction of the composite into a polymer matrix.

In this embodiment of the invention, the composite product may contain for example from 0.5 to 5% by weight of nanotubes.

The polymer matrix generally contains at least one polymer selected from gradient, block, random or stereoblock homopolymers or copolymers, thermoplastic or thermosetting homopolymers or copolymers, rigid or elastomeric homopolymers or copolymers, and crystalline, semicrystalline or amorphous homopolymers or copolymers. Preferably, according to the invention, at least one thermoplastic polymer and/or at least one elastomer are used, which may in particular be selected from those listed above.

When the composite prepared as described above comprises a polystyrene-polybutadiene-poly(C₁-C₈ alkyl methacrylate) type or SBM polymer, the polymer matrix may especially include a polymer such as polyvinylchloride or PVC.

The polymer matrix may also contain various adjuvants and additives, such as lubricants, pigments, stabilizers, fillers or reinforcements, antistatic agents, fungicides, fire retardants and solvents.

In this embodiment of the invention, the composite product obtained may be used for the manufacture of fluid transporting or storage devices, such as pipes, tanks, offshore pipes or hoses, for example for the purpose of preventing the build-up of electrostatic charge. As a variant, this composite product may be used for the manufacture of dense or porous electrodes, especially for supercapacitors or fuel cells.

In certain embodiments of the invention, the composite obtained according to the invention may be used to stiffen and/or thicken a liquid formulation, which may or may not contain a polymer matrix. This liquid formulation then contains at least one solvent for the thermoplastic polymer. For example, if the thermoplastic polymer is a water-soluble polyethylene glycol, the liquid formulation may contain water. The invention thus offers a means for stiffening and/or thickening a liquid formulation containing at least one solvent for the thermoplastic polymer, for example in particular an ink, varnish, paint, mastic, bituminous product or concrete composition. The subject of the invention is therefore also the aforementioned use of the composite material described above.

In other embodiments, the composite according to the invention may be used to manufacture conducting fibres (obtained in particular by melt processing) or conducting monolayer or multilayer films, i.e. having in general an electrical resistivity ranging from 10¹ to 10 ohms·cm. It has in fact been demonstrated that the method according to the invention makes it possible to obtain composites typical of being converted in particular into extruded films or fibres having better electrical conductivity and as good mechanical properties as those of the prior art, probably due to the fact of the absence of nanotube aggregates generating defects in these fibres and films and/or greater mobility of the nanotubes. These fibres may in particular be employed in the manufacture of conducting fabrics. In these applications, it is preferred for the plasticizer to be selected from: cyclic oligobutyl (or polybutylene) terephthalates functionalized amphiphilic hydrocarbons, alkylsulphamides and mixtures thereof.

The invention will be better understood in the light of the following purely illustrative non-limiting examples in combination with the appended figures in which:

FIG. 1 illustrates the resistivity curve as a function of temperature of a composite product obtained according to the invention and of a comparative composite product based on PA-12;

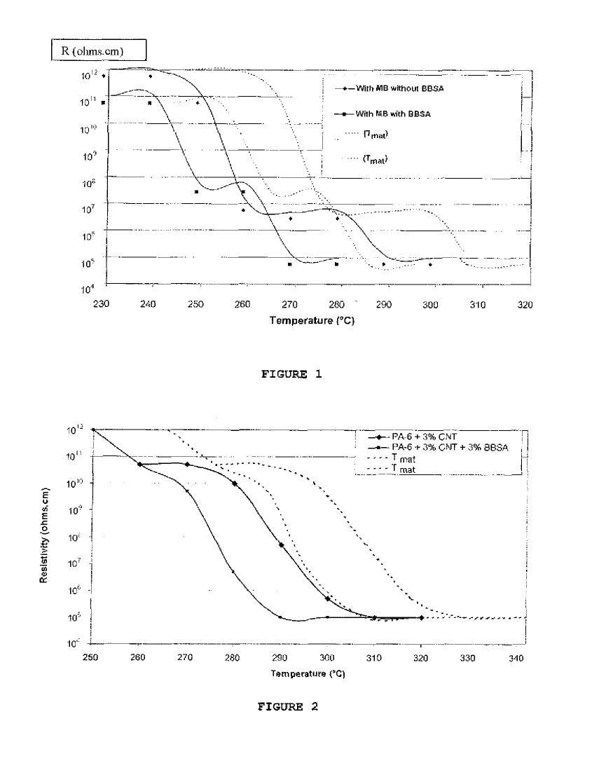

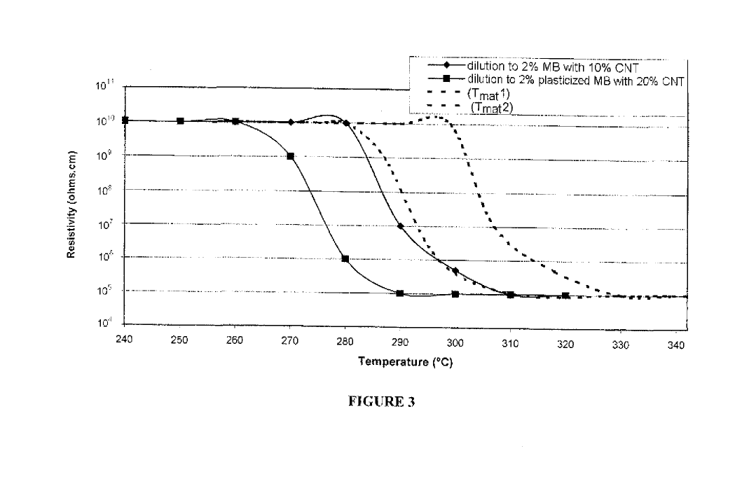

FIG. 2 illustrates the resistivity curve as a function of temperature of a composite product obtained according to the invention and a comparative composite product based on PA-6; and

FIG. 3 illustrates the resistivity curve as a function of temperature of a composite product obtained according to the invention and a comparative composite product based on a polycarbonate.

### EXAMPLES

### Example 1

### Manufacture of Polyamide CNT/Nylon-12 Composites

Two formulations, namely 1A (comparative formulation) and 1B (formulation according to the invention), the compositions of which are indicated in Table 2, were introduced into a BUSS® MDK 46 co-kneader (L/D=11).

TABLE 2

| | Formulation 1A | Formulation 1B |
|---|---|---|
| Nanotubes: | 20% | 20% |
| CNT (Graphistrength ® C100 | | |
| from ARKEMA) | | |
| Polymer 1: | 75% | 50% |
| PA-12 (AMNO TLD Rilsan ® | | |
| powder from ARKEMA, | | |
| 150-300 μm) | | |
| Polymer 2: | 5% | 5% |
| PA-12 (AMNO TLD Rilsan ® | | |
| granules from ARKEMA) | | |
| Plasticizer: | — | 25% |
| BBSA (liquid) | | |

The all-solid ingredients of Formulation 1A were introduced into a single hopper. The ingredients of Formulation 1B were partly introduced into the same hopper (polyamide and nanotubes) and partly injected (BBSA) with a gravimetric metering pump into the first zone of the co-kneader, which corresponds to the start of melting of the polymer. The temperature setpoints and the throughputs were identical for the two formulations (zone 1/zone 2 of co-kneader: 280/290° C.; throughput: 13 kg/h).

It was observed that Formulation 1A was more viscous and resulted in the co-kneader having a power consumption of 5.8-5.9 kW, therefore close to the nominal power (6.0 kW) indicated by the manufacturer. Furthermore, the temperature of the material in the last zone of the co-kneader rose to about 315° C.

In contrast, the power drawn by Formulation 1B, which was less viscous, was only 5.0-5.2 kW and the production conditions remained steady. The temperature of the material in the final zone of the co-kneader was only 295° C.

Moreover, it was observed that Formulation 1A generated deposits in the co-kneader, unlike Formulation 1B.

It follows from this example that the method according to the invention makes it possible to manufacture a composite highly filled with nanotubes under milder conditions than a method not using a plasticizer. This method therefore makes it possible for composites to be continuously manufactured without degrading the polymer matrix or causing unacceptable contamination of the equipment.

### Example 2

### Manufacture of Composites from CNT/Nylon-12 Composites

The composites of Example 1 were diluted in PA-12 in a co-rotating twin-screw extruder (diameter: 16 mm; L/D=25) at various temperatures so as to obtain composite products containing 2% CNT by weight.

The resistivity of the composite products obtained was then measured and the curve illustrated in FIG. 1 plotted.

As is apparent from this figure, in the process window (i.e. the conversion temperature range) defined by the polymer manufacturer, i.e. 230-290° C., the composite product manufactured according to the invention (MB with BBSA) has electrical conduction properties at lower temperatures than the comparative composite product (MB without BBSA). The invention therefore makes it possible to obtain composite products under milder process conditions, preserving the polymer matrix.

Very similar results were obtained by replacing the PA-12 of Examples 1 and 2 with PA-11 (Rilsan® BMNO TLD from Arkema).

### Example 3

### Manufacture of CNT/Nylon-6 Composites

Two formulations, namely 3A (comparative formulation) and 3B (formulation according to the invention), the compositions of which are given in Table 3, were introduced into a BUSS® MDK 46 co-kneader (L/D=11).

TABLE 3

| | Formulation 3A | Formulation 3B |
|---|---|---|
| Nanotubes: | 20% | 20% |
| CNT (Graphistrength ® C100 | | |
| from ARKEMA) | | |
| Polymer 1: | 75% | 60% |
| PA-6 (Grade: 150-300 μm | | |
| Domamid ® 24 powder from | | |
| Domo Chemicals) | | |
| Polymer 2: | 5% | 5% |
| PA-6 (Grade: Domamid ® 24 | | |
| granules from | | |
| Domo Chemicals) | | |
| Plasticizer: | — | 15% |
| BBSA (liquid) | | |

The all-solid ingredients of Formulation 3A were introduced into a single hopper. The ingredients of Formulation 3B were partly introduced into the same hopper (polyamide and nanotubes) and partly injected with a gravimetric metering pump, on the one hand (10% BBSA) in the first zone of the co-kneader corresponding to the start of melting of the polymer and, on the other hand (5% BBSA), in the second zone of the co-kneader, downstream of this melting zone. The temperature setpoints and the throughputs were the same for both formulations (zone 1/zone 2 of the co-kneader: 290/290° C.; throughput: 11 kg/h).

It was observed that Formulation 3A was more viscous and resulted in a co-kneader power consumption of 5.7-5.8 kW, which after 10 h of compounding exceeded the nominal power (6.0 kW) indicated by the manufacturer, thus requiring the throughput to be lowered to 10 kg/h. Furthermore, the temperature of the material in the final zone of the co-kneader rose to about 320° C.

In contrast, the power drawn by Formulation 3B, which was less viscous, was only 5.4-5.6 kW and the production conditions remained steady. The material temperature in the final zone of the co-kneader was only 300° C. Furthermore, there was no contamination on the walls of the machine, unlike in the method using Formulation 3A.

It is apparent from this example that the method according to the invention makes it possible for composites highly filled with CNT to be continuously manufactured without degrading the polymer matrix or contaminating the equipment.

### Example 4

### Manufacture of Composite Products from CNT/Nylon-6 Composites

The composites of Example 3 were diluted in PA-6 in a co-rotating twin-screw extruder (diameter: 16 mm; L/D=25), at various temperatures so as to obtain composite products containing 3% CNT by weight.

The resistivity of the composite products obtained was measured and the curve illustrated in FIG. 2 plotted.

As is apparent from this figure, processing the composite manufactured according to the invention makes it possible to reduce the temperature for manufacturing a composite product by 20° C., while still giving said product the same electrostatic dissipation properties.

### Example 5

### Manufacture of CNT/Polycarbonate Composites

Two formulations, namely 5A (comparative formulation) and 5B (formulation according to the invention), the compositions of which are indicated in Table 4, were introduced into a BUSS® MDK 46 co-kneader (L/D=11).

TABLE 4

| | Formulation 5A | Formulation 5B |
|---|---|---|
| Nanotubes: | 15% | 20% |
| CNT (Graphistrength ® C100 | | |
| from ARKEMA) | | |
| Polymer 1: | 80% | 45% |
| polycarbonate (Grade: | | |
| 150-300 μm Makrolon ® 2207 | | |
| powder from BAYER,) | | |
| Polymer 2: | 5% | 5% |
| polycarbonate (Grade: | | |
| Makrolon ® 2207 granules | | |
| from BAYER) | | |
| Plasticizer: | — | 30% |
| Bisphenol A(bis-diphenyl | | |
| phosphate), NcendX ® P30 from | | |
| ALBEMARLE (liquid) | | |

The all-solid ingredients of Formulation 5A were introduced into a single hopper. The ingredients of Formulation 5B were partly introduced into the same hopper (polycarbonate and nanotubes) and partly injected with a gravimetric metering pump, fitted with a system for heating the liquid to 80° C., in the first zone of the co-kneader corresponding to the start of melting of the polymer. The temperature setpoints were similar for both formulations (zone 1/zone 2 of the co-kneader: 300/260° C. and 310/270° C.).

It should be noted that it was not possible to raise the CNT content in Formulation 5A to 20% without causing degradation of the composite formed. Furthermore, even at the CNT content tested, the material temperature exceeded 320° C. for a very moderate throughput of 10-11 kg/h.

In contrast, using Formulation 5B which nevertheless contained 20% CNT by weight, the production remained steady for about 40 h with a throughput of 15 kg/h, without the material temperature exceeding 300° C.

It follows from this example that the method according to the invention allows composites highly filled with CNT to be continuously manufactured without degrading the polymer matrix.

These composites, such as Formulation 5B, may be diluted down to 2-3% by weight of CNT in a polymer matrix based on polycarbonate, ABS resin or ABS/styrene copolymer for the manufacture of conductive materials that are fire-retardant (i.e. having a V0 index in the UL94 fire test and an LOI of greater than 32%).

### Example 6

### Manufacture of Composite Products from CNT/Polycarbonate Composites

The composites of Example 5 were diluted in a polycarbonate in a co-rotating twin-screw extruder (diameter: 16 mm; L/D=25) at various temperatures so as to obtain composites containing 2% CNT by weight.

The resistivity of the composite products obtained was measured and the curve illustrated in FIG. 3 plotted.

As is apparent from this figure, processing the composite manufactured according to the invention makes it possible to reduce the temperature for manufacturing the composite product by 20° C. while still giving said product the same electrostatic dissipation properties.

### Comparative Example 7

### Manufacture of a CNT/PA-6 Composite

Example 3 was repeated except that the plasticizer was entirely introduced into the co-kneader downstream of the melting zone of the PA-6.

An increase in the material temperature was observed in this zone up to more than 300° C., and also a change in the power drawn by the machine, which went from 5.5 kW to 6 kW after about 10 h. The production had to be stopped after operating for 12 h.

This example consequently illustrates the advantages afforded by the method according to the invention (Example 3) compared with a similar method in which the plasticizer is introduced downstream of the polymer melting zone.

### Example 8

### Manufacture of a CNT/PEG Masterbatch in a Co-Kneader

A precomposite containing 25% by weight of carbon nanotubes (Graphistrength® C100 from ARKEMA), 20% by weight of a polyethylene glycol powder (PEG 1500 from CLARIANT), 20% by weight of carboxymethyl cellulose from CLARIANT and 10% by weight of sodium dodecylbenzenesulphonate were introduced into the first feed hopper of a BUSS MDK 46 co-kneader (L/D=11) fitted with a take-up extruder. 25% by weight of propylene glycol was also injected as plasticizer into the 1^{st} kneading zone. The temperature setpoints within the co-kneader were the following: 80° C./100° C. (zone 1/zone 2); 80° C. (take-up extruder).

The percentage contents given above are for 100% by weight of the masterbatch obtained.

The masterbatch was conditioned in the solid state without die-face granulation. It may be diluted in an aqueous-base paint formulation.

### Example 9

### Manufacture of a CNT/PEG Masterbatch in an Extruder

A precomposite containing 50% propylene glycol by weight and 50% carbon nanotubes (Graphistrength® C100 from ARKEMA) by weight were introduced into the first metering zone of a CLEXTRAL BC21 co-rotating twin-screw extruder. A powder blend consisting of 40% polyethylene glycol (PEG 1500 from CLARIANT) by weight, 40% carboxymethyl cellulose (from CLARIANT) by weight and 20% sodium dodecylbenzenesulphonate by weight was introduced into the second metering zone of the extruder.

The compounding was carried out at a setpoint temperature of 100° C. with a screw rotation speed of 600 rpm and a throughput of 10 kg/h.

The masterbatch obtained, which contained (number to be inserted) % by weight of CNT, was conditioned in the solid state without die-face granulation.

It may be introduced into a solvent formulation after having been impregnated for a few hours, at room temperature, with a solvent mixture present in said formulation.

### Example 10

### Manufacture of CNT/SBM Composites

Two formulations, namely 10A and 10B according to the invention, the composition of which are indicated in Table 5, were introduced into a BUSS® MDK 46 co-kneader (L/D=11)

TABLE 5

| | Formulation 10A | Formulation 10B |
|---|---|---|
| Nanotubes: | 30% | 30% |
| CNT (Graphistrength ® C100 | | |
| from ARKEMA) | | |
| Polymer 1: | 60% | 30% |
| SBM copolymer (Nanostrength ® | | |
| E41 powder grade from | | |
| ARKEMA) | | |
| Polymer 2: | 0% | 10% |
| SBM copolymer (Durastrength ® | | |
| E920 powder grade from | | |
| ARKEMA) | | |
| Plasticizer: | 10% | 0% |
| liquid nitrile resin | | |
| (Nipol ®312 LV from Zeon) | | |
| Plasticizer: | 0% | 30% |
| dioctylphtalate (Garbeflex ® | | |
| from ARKEMA) | | |

The solid ingredients of Formulation 10A and 10B were partly (polymer and nanotubes) introduced into the same feed hopper and partly (plasticizer) injected a graviometric metering pump into the first zone of the co-kneader, which corresponds to the start of the melting of the polymer. The pump was fitted with a system for heating the liquid to 160° C. for the Formulation 8A and to 100° C. for Formulation 8B. The temperature set points were similar for both formulations (zone 1/zone 2 of the co-kneader: 220/200° C.).

Thanks to the plastification, the material temperature did not exceed 240° C. despite the high amount of CNTs (30%). It follows from this example that the method according to the invention allows composites highly filled with CNTs to be continuously manufactured without degrading the polymer matrix.

1. Method for preparing a composite containing 10 to 50% by weight of nanotubes, comprising:
(a) introducing into a mixer, a polymeric composition containing at least one thermoplastic polymer and nanotubes;
(b) melting the thermoplastic polymer; and
(c) mixing the molten thermoplastic polymer and the nanotubes,
the method further comprising adding at least one plasticizer into the mixer, in a weight ratio of 10 to 400% by weight, relative to the weight of nanotubes employed, at least 50% of the weight of plasticizer being introduced prior to or during the melting of the polymer,
provided that, the plasticizer, the thermoplastic polymer and the nanotubes are introduced simultaneously or in succession into the mixer, the polymer is in the form of a powder/granule mixture ranging from 10:90 to 100:0.

2. Method according to claim 1, characterized in that the thermoplastic polymer is selected from the group consisting of: olefin homopolymers and copolymers; acrylic homopolymers and copolymers; homopolyamides and copolyamides; polycarbonates; polyesters; polyethers; polystyrene; styrene/maleic anhydride copolymers; polyvinyl chloride; fluoropolymers; natural or synthetic rubbers; thermoplastic polyurethanes; polyaryletherketones (PAEK); polyetherimide; polysulphone; polyphenylenesulphide; cellulose acetate; polyvinyl acetate; and blends thereof.

3. Method according to claim 1, characterized in that the plasticizer is selected from the group consisting of:
phosphate alkyl esters and alkyl esters of hydrobenzoic acid, lauric acid, azelaic acid and pelargonic acid;
arylphosphates;
phthalates;
nitrile resins;
cyclized polybutylene terephthalate and mixtures containing such;
adipates;
sebacates;
glycol benzoates or glycerol benzoates;
dibenzyl ethers,
chloroparaffins;
functionalized amphiphilic hydrocarbons;
propylene carbonate;
sulphonamides;
salts of N-alkyl guanidine;
glycols; and
mixtures thereof.

4. Method for preparing a composite, containing 10 to 50% by weight of nanotubes, comprising:
(a) introducing into a mixer, nanotubes and a polymeric composition containing at least one thermoplastic polymer comprising a homopolyamide or copolyamide;
(b) melting the thermoplastic polymer; and
(c) mixing the molten thermoplastic polymer and the nanotubes,
the method further comprising adding at least one plasticizer into the mixer, selected from the group consisting of sulphonamides, hydroxybenzoates, phthalates, adipates and phosphates,
in a weight ratio of 10 to 400% by weight relative to the weight of nanotubes employed, at least 50% of the weight of the plasticizer being introduced prior to or during, the melting of the polymer,
provided that, the plasticizer, the thermoplastic polymer and the nanotubes are introduced simultaneously or in succession into the mixer, the polymer is in the form of a powder/granule mixture ranging from 10:90 to 100:0.

5. Method for preparing a composite containing 10 to 50% by weight of nanotubes, comprising:
(a) introducing into a mixer, nanotubes and a polymeric composition containing at least one thermoplastic polymer comprising a polycarbonate;
(b) melting the thermoplastic polymer; and
(c) mixing the molten thermoplastic polymer and the nanotubes,
the method further comprising adding at least one plasticizer into the mixer, selected from phosphate alkyl esters, aryl phosphates and phthalates,
in a weight ratio of 10 to 400% by weight relative to the weight of nanotubes employed, at least 50% of the weight of the plasticizer being introduced prior to or during the melting of the polymer.

6. Method for preparing a composite containing 10 to 50% by weight of nanotubes, comprising:
(a) introducing into a mixer, nanotubes and a polymeric composition containing at least one thermoplastic polymer comprising a styrene-butadiene-methyl methacrylate copolymer;
(b) melting the thermoplastic polymer; and
(c) mixing the molten thermoplastic polymer and the nanotubes,
the method further comprising adding at least one plasticizer into the mixer, selected from phtalates and nitrile resins,
in a weight ratio of 10 to 400% by weight relative to the weight of nanotubes employed, at least 50% of the weight of the plasticizer being introduced prior to or during the melting zone of the polymer.

7. Method for preparing a composite containing 10 to 50% by weight of nanotubes, comprising:
(a) introducing, into a mixer, nanotubes and a polymeric composition containing at least one thermoplastic polymer comprising a polyethylene glycol;
(b) melting the thermoplastic polymer; and
(c) mixing the molten thermoplastic polymer and the nanotubes,
the method further comprising adding at least one plasticizer into the mixer, selected from glycols,
in a weight ratio of 10 to 400% by weight relative to the weight of nanotubes employed, at least 50% of the weight of the plasticizer being introduced prior to or during the melting of the polymer

8. Method according to claim 1, characterized in that the mixer is a compounding device.

9. Method according to claim 1, characterized in that the plasticizer, the thermoplastic polymer and the nanotubes are introduced simultaneously or in succession into the mixer.

10. Method according to claim 1, characterized in that the plasticizer is introduced into the mixer prior to melting of the polymer.

11. Method according to claim 1 characterized in that the nanotubes are carbon nanotubes.

12. Method according to claim 1, characterized in that the amount of nanotubes employed is from 15 to 40% by weight relative to the total weight of the composite.

13. Method according to claim 1, characterized in that the plasticizer is selected from the group consisting of: N-butylbenzenesulphonamide (BBSA), N-ethylbenzenesulphonamide (EBSA), N-propylbenzenesulphonamide (PBSA), N-butyl-N-dodecylbenzenesulphonamide (BDBSA), N,N-dimethylbenzenesulphonamide (DMBSA), para-methylbenzenesulphonamide, ortho-toluenesulphonamide, para-toluenesulphonamide, resorcinol bis(diphenyl phosphate), bisphenol A bis(diphenyl phosphate), neopentylglycol bis(diphenyl phosphate), dioctylphthalate, glycols, functionalized amphiphilic hydrocarbons, cyclized polybutylene terephthalate and mixtures thereof.

14. Method according to claim 1, characterized in that the plasticizer represents from 5 to 80% by weight relative to the total weight of the composite.

15. Composite that obtained by the method according to claim 1.

16-19. (canceled)

20. Process for manufacturing a composite comprising:
manufacturing a composite by the method according to claim 1; and
introducing the composite into a polymer matrix.

21. Method of claim 2 wherein said olefin homopolymers and copolymers are selected from the group consisting of acrylonitrile-butadiene-styrene copolymers, styrene-butadiene-alkylmethacrylate copolymers, polyethylene, polypropylene, polybutadiene and polybutylene.

22. Method of claims 2 wherein said acrylic homopolymers and copolymers are polyalkyl (meth)acrylates.

23. Method of claim 2 wherein said polyesters are selected from the group consisting of polyethylene terephthalate and polybutylene terephthalate.

24. Method of claim 2 wherein said polyethers are selected from the group consisting of polyphenylene ether, polyoxymethylene, polypropylene glycol and polyoxypropylene.

25. Method of claim 2 wherein said fluoropolymers are selected from the group consisting of polyvinylidene fluoride, polytetrafluoroethylene and polychlorotrifluoroethylene.

26. Method of claim 2 wherein said polyaryletherketones (PAEK) is selected from the group consisting of polyetheretherketone (PEEK) and polyetherketoneketone (PEKK).

27. Method of claim 3 wherein said phthalates are alkybenzyl phthalates, the alkyl groups, which are linear or branched, independently containing 1 to 12 carbon atoms.

28. Method of claim 12 wherein the amount of nanotubes employed is relative to the total weight of the composite.
